(19) United States
(12) Patent Application Publication
(10) Pub. No.: US 2025/0379864 A1
(43) Pub. Date: Dec. 11, 2025

(54) AUTOMATED USER-CENTRIC SERVER MANAGEMENT

(71) Applicant: Dell Products L.P., Round Rock, TX (US)

(72) Inventors: Abhishek Mishra, Bangalore (IN); Vivek Bhargava, Bangalore (IN); David C. Sydow, Merrimack, NH (US); Dev Kathuria, Greater Noida (IN); Marina Shem Tov, Hod Hasharon (IL)

(21) Appl. No.: 18/739,632

(22) Filed: Jun. 11, 2024

(51) Int. Cl. H04L 9/40; G06F 9/50

(52) U.S. Cl. CPC H04L 63/10; G06F 9/505

(57) ABSTRACT

Methods, apparatus, and processor-readable storage media for automated user-centric server management are provided herein. An example computer-implemented method includes obtaining requests for server-related resource(s) access in connection with at least one time period; identifying at least a first portion of the requests as corresponding to a first category of user type and at least a second portion of the requests as corresponding to a second category of user type by processing user credentials from the requests; automatically processing the first portion of the requests; prioritizing, in a request queue data structure, the second portion of the requests based on request volume parameters related to the time period(s) and at least a subset of the corresponding user credentials; and automatically processing, during the time period(s), the second portion of the requests from the request queue data structure in accordance with the prioritizing.

### BACKGROUND

In many environments and/or use cases, handling server overload during peak usage periods presents challenges. For example, users with special credentials, such as privileged access, often expect uninterrupted service even under heavy traffic loads. However, conventional server management approaches fail to effectively maintain server performance during heavy usage periods while ensuring uninterrupted access for privileged users, and such conventional approaches commonly induce usage latencies and/or expand server-related costs.

### SUMMARY

Illustrative embodiments of the disclosure provide techniques for automated user-centric server management.

An exemplary computer-implemented method includes obtaining multiple requests for access to one or more server-related resources in connection with at least one time period, and identifying at least a first portion of the multiple requests as corresponding to a first category of user type and at least a second portion of the multiple requests as corresponding to a second category of user type by processing user credentials associated with the multiple requests. The method also includes automatically processing, during the at least one time period, the first portion of the multiple requests corresponding to the first category of user type, and prioritizing, in at least one request queue data structure, the second portion of the multiple requests corresponding to the second category of user type based at least in part on one or more request volume parameters related to the at least one time period and at least a subset of the user credentials associated with the second portion of the multiple requests. Further, the method additionally includes automatically processing, during the at least one time period, at least part of the second portion of the multiple requests corresponding to the second category of user type from the at least one request queue data structure in accordance with the prioritizing of the second portion of the multiple requests.

Illustrative embodiments can provide significant advantages relative to conventional server management approaches. For example, problems associated with an inability to differentiate between regular users and privileged users, while inducing usage latencies and/or expanding server-related costs, are overcome in one or more embodiments through automatically prioritizing and processing server requests based at least in part on user credentials associated with the requests.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for automated user-centric server management in an illustrative embodiment.

FIG. 2 shows an example algorithm for implementing automated user-centric server management in an illustrative embodiment.

FIG. 3 shows example pseudocode for implementing automated user-centric server management in an illustrative embodiment.

FIG. 4 is a flow diagram of a process for automated user-centric server management in an illustrative embodiment.

FIGS. 5 and 6 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

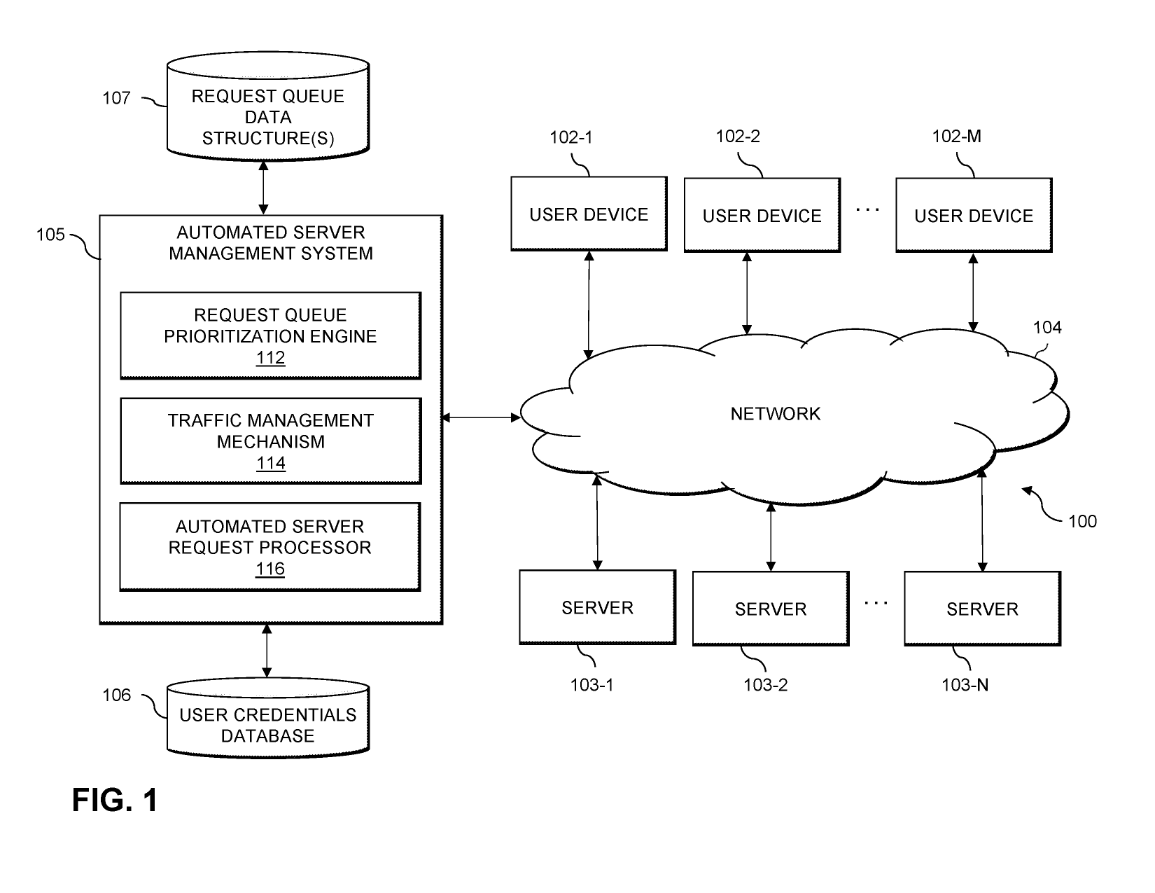

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102, and a plurality of servers 103-1, 103-2, ... 103-N, collectively referred to herein as servers 103. The user devices 102 and servers 103 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is automated server management system 105.

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

Also, as used herein, the servers 103 can include hardware and one or more operating systems which form at least one foundational layer, providing a physical and software platform. In one or more embodiments, network interfaces connect servers 103 to clients (e.g., user devices 102), while web server software handles hypertext transfer protocol (HTTP) and/or hypertext transfer protocol secure (HTTPS) requests. By way of example, servers 103 can include application servers, which can process dynamic content, often supported by one or more load balancers and one or more reverse proxies to enhance performance. By way of further example, servers 103 can include database servers, which can manage data storage and retrieval, using caching mechanisms such as, e.g., in-memory systems and/or content delivery networks (CDNs) to improve response times. Additionally, in at least one embodiment, servers 103 can include one or more security measures such as, e.g., firewalls, secure sockets layer (SSL) and/or transport layer security (TLS) to ensure secure communication, and one or more monitoring tools to track performance and maintain high availability through scaling and failover mechanisms.

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the automated server management system 105 can have an associated user credentials database 106 configured to store data pertaining to user identifying information with respect to one or more server-related resources and/or server-related services. Also, as depicted in FIG. 1, the automated server management system 105 can have one or more request queue data structures 107 configured to store data pertaining to server requests and prioritization-related information associated with various users.

The user credentials database 106 and/or request queue data structure(s) 107 in the present embodiment can be implemented using one or more storage systems associated with the automated server management system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the automated server management system 105 are one or more input-output devices, which illustratively comprise keyboards, displays or other types of input-output devices in any combination. Such input-output devices can be used, for example, to support one or more user interfaces to the automated server management system 105, as well as to support communication between the automated server management system 105 and other related systems and devices not explicitly shown.

Additionally, the automated server management system 105 in the FIG. 1 embodiment is assumed to be implemented using at least one processing device. Each such processing device generally comprises at least one processor and an associated memory, and implements one or more functional modules for controlling certain features of the automated server management system 105.

More particularly, the automated server management system 105 in this embodiment can comprise a processor coupled to a memory and a network interface.

The processor illustratively comprises a microprocessor, a central processing unit (CPU), a graphics processing unit (GPU), a tensor processing unit (TPU), a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the automated server management system 105 to communicate over the network 104 with the user devices 102, and illustratively comprises one or more conventional transceivers.

The automated server management system 105 further comprises resource queue prioritization engine 112, traffic management mechanism 114, and automated server request processor 116.

It is to be appreciated that this particular arrangement of elements 112, 114 and 116 illustrated in the automated server management system 105 of the FIG. 1 embodiment is presented by way of example only, and alternative arrangements can be used in other embodiments. For example, the functionality associated with elements 112, 114 and 116 in other embodiments can be combined into a single module, or separated across a larger number of modules. As another example, multiple distinct processors can be used to implement different ones of elements 112, 114 and 116 or portions thereof.

At least portions of elements 112, 114 and 116 may be implemented at least in part in the form of software that is stored in memory and executed by a processor.

It is to be understood that the particular set of elements shown in FIG. 1 for automated user-centric server management involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, two or more of automated server management system 105, user credentials database 106, and request queue data structure(s) 107 can be on and/or part of the same processing platform.

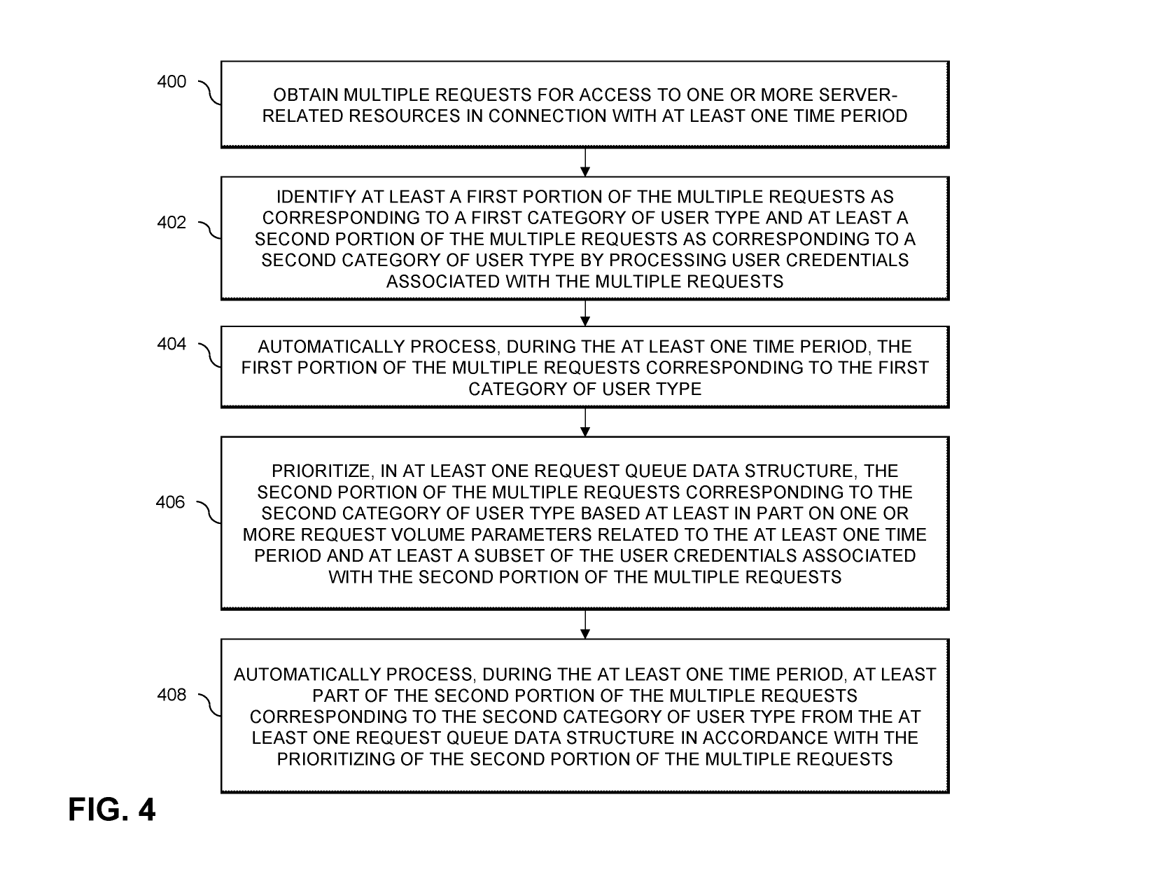

An exemplary process utilizing elements 112, 114 and 116 of an example automated server management system 105 in computer network 100 will be described in more detail with reference to the flow diagram of FIG. 4.

Accordingly, at least one embodiment includes automated user-centric server management. As further detailed herein, such an embodiment includes leveraging traffic management techniques and request queue prioritization techniques in connection with privileged users. By way merely of example, various criteria can be used to determine and/or identify privileged users with respect to one or more given servers. For instance, if an application offers subscription-based services, different subscription tiers can allow different levels of access (e.g., higher-tier subscribers can be considered privileged users). As another example, partners, key clients, strategic users, and/or users who are likely to place high value transactions can be considered privileged users who might require uninterrupted access. Additionally or alternatively, users with service-level agreements (SLAs) that guarantee certain response times and/or service availability can be considered privileged users.

As such, one or more embodiments include combining traffic management and priority queuing techniques to prioritize and/or enhance user experience for privileged users during server overload periods. By way merely of example, in connection with such an embodiment, peak periods can refer to times when online services experience an unusually high volume of user activity, leading to significant increases in server load and resource demand. Such periods can occur, for example, during special events, sales, holidays, etc., when user engagement surges. Managing server overload during such times, as further detailed herein in connection with one or more embodiments, is important to maintain server performance, prevent server downtime, and/or facilitate a seamless user experience.

With respect to traffic management, at least one embodiment can include implementing a mechanism that controls the maximum number of requests which regular users (i.e., non-privileged users) can make within at least one defined time. With respect to request queue prioritization, at least one embodiment can include assigning one or more priority levels to incoming requests based at least in part on user credentials associated with the requests. For example, privileged users, identified by special and/or predetermined credentials, can be assigned higher priorities as compared to regular and/or non-privileged users. As such, in at least one embodiment, a priority queue is established to temporarily store incoming requests, and the queue is ordered based at least in part on the priority levels assigned to the requests. During a server overload period, such an embodiment can include serving requests from the priority queue, starting with the highest priority (e.g., privileged users) and ensuring their prompt access to corresponding services and/or resources.

By way of example, requests being processed and/or prioritized, as noted above and further detailed herein, can include any HTTP request made to a sever. More particularly, examples of such HTTP requests can include web page requests, application programming interface (API) calls, database queries, authentication and/or authorization actions, media streaming, search queries, transaction processing, resource updates, etc. With respect to web page requests, users can request hypertext markup language (HTML) pages, cascading style sheets (CSS), JavaScript files and/or images, etc., which can be essential for displaying web pages. With respect to API calls, applications can make numerous API requests to fetch and/or update data, such as user information, product details, real-time updates, etc. With respect to database queries, intensive read and write operations to databases can occur as users interact with at least one given service, such as adding items to a virtual shopping cart, checking account balances, etc. With respect to authentication and authorization actions, high volumes of login and/or verification requests can occur as users access accounts and/or services. With respect to media streaming, requests can be made for streaming video and/or audio content, which can significantly strain server bandwidth and processing power. With respect to search queries, users can perform a high volume of searches, requiring a server to handle and return search results promptly. With respect to transaction processing, numerous payment processing and/or order placement requests can be placed and/or occur in a short period of time (e.g., simultaneously), straining server bandwidth. Also, with respect to resource updates, users can upload and/or download files, update profiles and/or modify other resources, increasing the load on a server.

By leveraging both traffic management and request queue prioritization, at least one embodiment can include providing an enhanced user experience for privileged users while maintaining fairness and preventing complete unavailability for regular users (e.g., non-privileged users) during periods of heavy usage and/or peak traffic (also referred to herein as periods of server overload). In such an embodiment, at least a portion of privileged users can bypass the traffic management mechanism, allowing such users uninterrupted access to server-related services and/or resources, even, e.g., if such users have exceeded one or more related request quotas. Regular users, in such an embodiment, can have their requests processed with reduced functionality and/or response time during periods of server overload.

As further detailed herein, in one or more embodiments, a request queue prioritization engine processes user credentials associated with requests (e.g., user credentials attributed to the users submitting the requests), and assigns priority levels to at least a portion of the requests based at least in part on the user credentials. Example credentials can include, e.g., authentication tokens, user role information, user access level information, and user identifiers (IDs), user account information, etc. More particularly, authentication tokens (e.g., JSON web tokens (JWTs)) can carry information about user identity and/or role, while user role information and/or user access level information can help determine user priority based at least in part on the user’s status (e.g., admin, premium member, etc.). User IDs (e.g., API keys) can be associated, for example, with priority access, and additional user metadata such as, e.g., status or account age, can also be used to determine user priority. By way of example, requests associated with users having certain credentials (e.g., privileged users) can be assigned higher priority than requests associated with users not having those certain credentials (e.g., regular users).

Additionally, in at least one embodiment, the request queue prioritization engine can generate and/or implement at least one priority queue to store at least a portion of incoming requests and process the incoming requests based at least in part on their priority levels during periods of heavy traffic and/or server overload. Such an embodiment can include creating at least one priority queue data structure to temporarily store incoming requests, ordered based on their assigned priority levels. Such a priority queue data structure can also facilitate efficient insertion and retrieval of elements (e.g., requests) based at least in part on their respective assigned priority levels.

More particularly, in one or more embodiments, when a request arrives, the request queue prioritization engine can authenticate the user submitting the request to determine the user’s status (e.g., privileged or regular) based at least in part on analysis of corresponding user credentials. For example, if the user is privileged, at least one embodiment includes immediately processing the request without delay or further analysis. For regular users, the request queue prioritization engine, in such an embodiment, can apply at least one usage quota by allocating a maximum request value in connection with a given time frame, as further detailed herein in connection with a traffic management mechanism. If a given regular user has exceeded their corresponding quota amount of requests, additional requests from that user can be placed in the priority queue with an appropriate priority level based at least in part on the user’s credentials.

As noted, in one or more embodiments, a traffic management mechanism regulates the rate of requests from regular users (e.g., non-privileged users), preventing such users from overwhelming the given server(s) during periods of heavy traffic and/or server overload. Requests that exceed one or more predefined threshold rates can be delayed, rejected and/or assigned a lower priority level by the traffic management mechanism. Additionally, in at least one embodiment, the traffic management mechanism defines one or more threshold values and/or quota values for regular users with respect to submitting requests during given time periods (e.g., during server overload). Such threshold values and/or quota values can be defined based at least in part on server capacity and/or one or more desired fairness parameters for at least one specific window of time. For example, the traffic management mechanism can determine and/or select appropriate values for the maximum number(s) of requests allowed to be submitted and/or processed within a given window of time (e.g., a maximum number of requests per second).

Further, for each incoming request from regular users, one or more embodiments include (e.g., via a traffic management mechanism) maintaining a request counter for each noted user. By way of example, when a request arrives and/or is obtained, the traffic management mechanism processes the request to determine if the user associated with the request has exceeded their corresponding request limit. If the user has reached or surpassed the maximum number of allowed requests, the traffic management mechanism can delay the request, reject the request with an appropriate error message, and/or apply a lower priority to the request for later processing in connection with the request queue prioritization engine (such as detailed above).

Accordingly, in one or more embodiments, during periods of server overload, request processing can be carried out in a prioritized manner connection with implementation and/or use of a priority queue. Such an embodiment can include initially processing requests from the highest priority level (e.g., privileged users) and then can proceed to processing requests from lower priority levels (e.g., regular users). Additionally, such an embodiment can be implemented as a standalone tool wherein users can register APIs, including user details (e.g., regular versus privileged), etc.

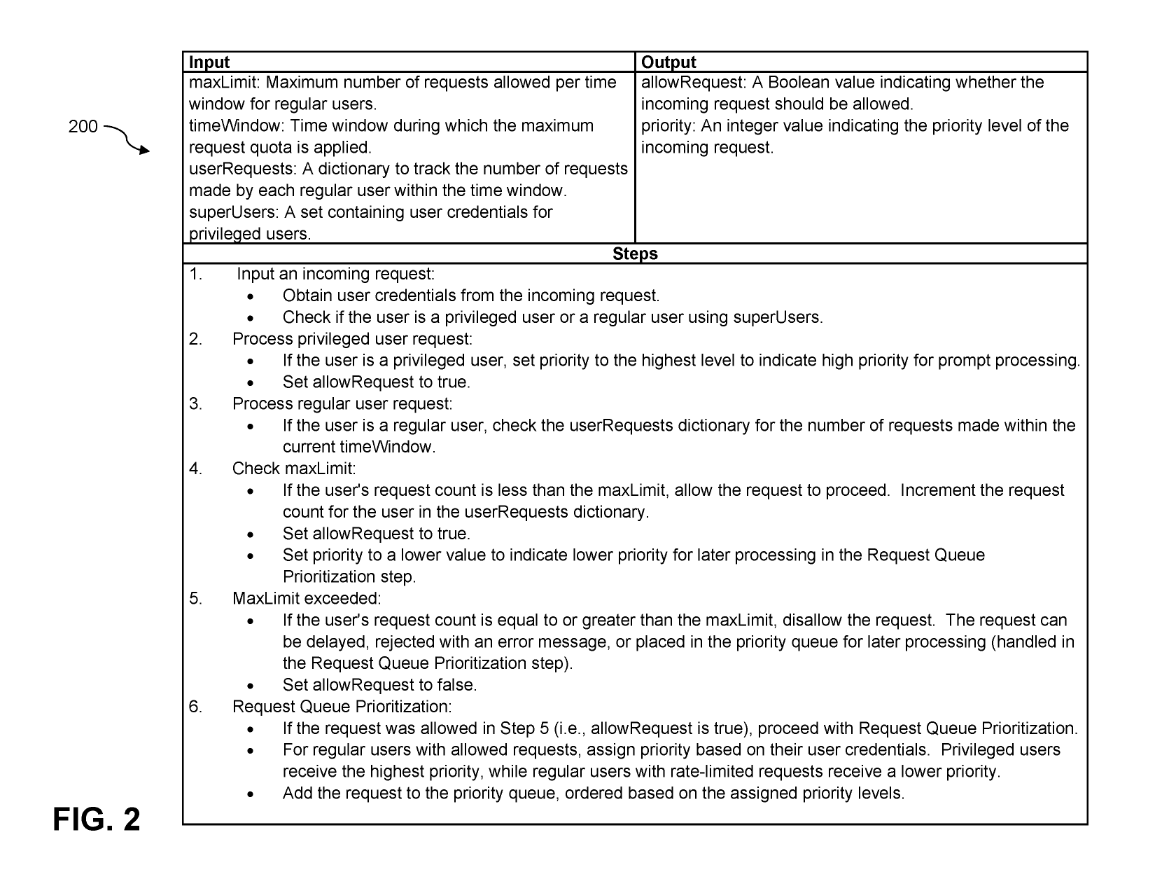

FIG. 2 shows an example algorithm for implementing automated user-centric server management in an illustrative embodiment. By way of illustration, algorithm 200 includes various inputs and outputs. For example, such inputs can include maxLimit, which represents the maximum number of requests allowed per time window for regular users; timeWindow, which represents the time window (e.g., in seconds) during which the maximum request quota (i.e., maxLimit) is to be applied; userRequests, which represents a dictionary to track the number of requests made by regular users within the time window; and superUsers, which represents a set containing user credentials for privileged users. Such outputs can include allowRequest, which represents a Boolean value indicating whether an incoming request should be allowed; and priority, which represents an integer value indicating the priority level of an incoming request.

As also depicted in FIG. 2, algorithm 200 can be carried out as follows. In a first step, an incoming request can be processed. More particularly, such processing includes obtaining and/or identifying user credentials associated with the incoming request, and determining if the user is a privileged user or a regular user using the superUsers set in connection with the obtained and/or identified user credentials. Algorithm 200 then includes processing privileged user requests in a second step. If the user associated with an incoming request is determined to be a privileged user in the previous step, priority attributed to that incoming request is set to the highest level to indicate high priority for prompt processing of the incoming request. Additionally, in connection with such actions, the algorithm can include setting allowRequest to true for that incoming request.

Additionally, in a third step, algorithm 200 includes processing regular user requests. If the user associated with an incoming request is determined to be a regular user, the userRequests dictionary is checked and/or analyzed for the number of requests made by that user within the current time window. Further, in a fourth step, algorithm 200 can include checking the maxLimit for the given (regular) user. More particularly, if the user’s request count is less than the maxLimit, the request can be allowed to proceed. The request count can then be incremented for the user in the userRequests dictionary, and allowRequest can be set to true. Also, the priority for the request can be set to a lower value to indicate lower priority for later processing in connection with the request queue prioritization engine.

Further, in a fifth step of algorithm 200, if it is determined that the user’s request count is equal to or greater than the maxLimit, the request is to be disallowed. More particularly, the request can be delayed, rejected with an error message, and/or placed in the priority queue for later processing (handled in connection with the request queue prioritization engine). In such an instance, algorithm 200 can also include setting allowRequest to false. Also, if the request was allowed (i.e., allowRequest is true), algorithm 200 can proceed, in a sixth step, with request queue prioritization. For regular users with allowed requests, algorithm 200 includes assigning priority levels based on the user credentials associated with the requests. In one or more embodiments, privileged users receive the highest priority (e.g., 1), while regular users with rate-limited requests receive a lower priority (e.g., 2). Additionally, an allowed request can then be added to at least one priority queue, ordered based at least in part on the assigned priority levels.

As detailed herein, by combining traffic management and priority queuing techniques, one or more embodiments include providing a robust solution to manage varying volumes of requests and varying priorities of users without reserving any additional resources for privileged users. Additionally, at least one embodiment includes dynamically adjusting priority values associated with requests based on user credentials of users submitting the requests. Accordingly, in such an embodiment, not all privileged users are treated equally, but the specific privileges of such users can impact and/or control their position in a priority queue. Further, one or more embodiments can be adaptable to varying server load conditions. For example, during normal operation, requests from regular users can be processed in accordance with normal procedures, and when the given server experiences heavy traffic and/or overload status, such an embodiment can include transitioning to serving requests from at least one priority queue, maintaining a balance between fairness and importance.

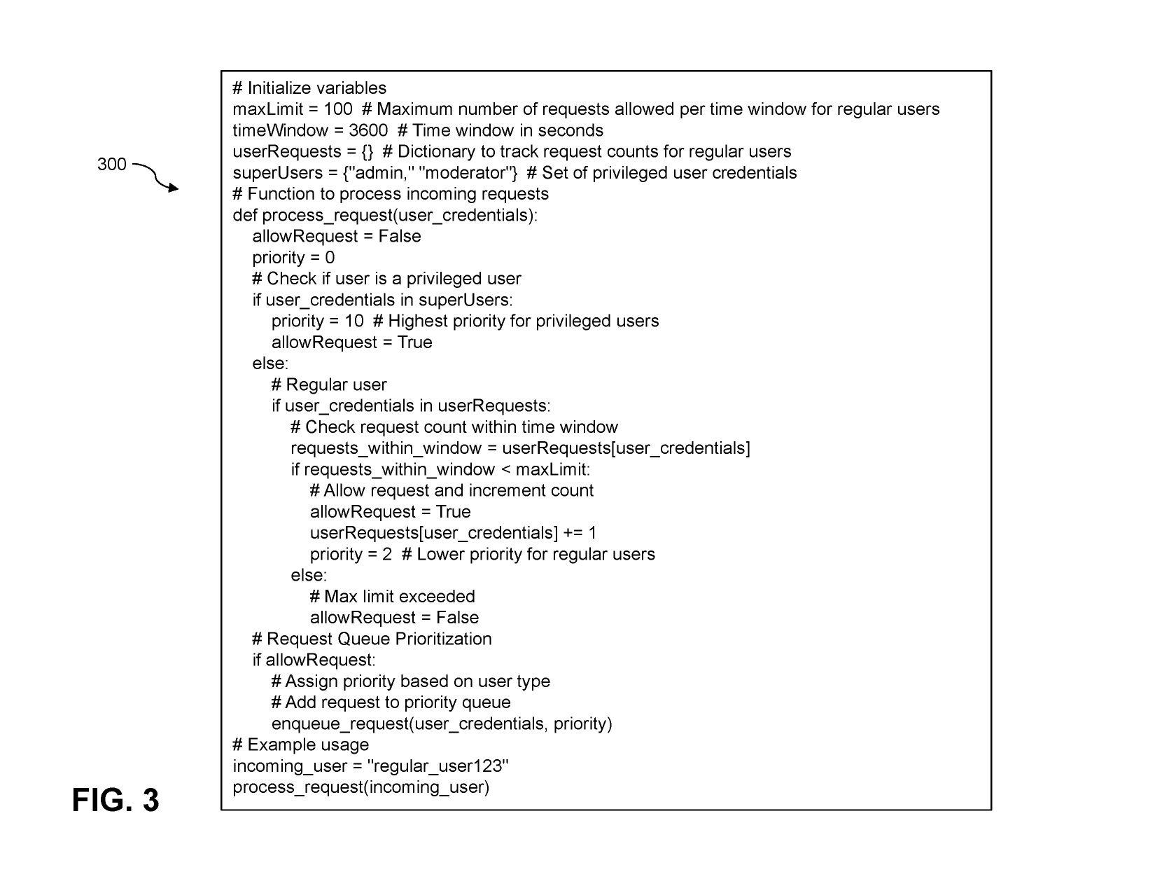

FIG. 3 shows example pseudocode for implementing automated user-centric server management in an illustrative embodiment. In this embodiment, example pseudocode 300 is executed by or under the control of at least one processing system and/or device. For example, the example pseudocode 300 may be viewed as comprising a portion of a software implementation of at least part of automated server management system 105 of the FIG. 1 embodiment.

The example pseudocode 300 illustrates initializing various variables such as, e.g., the maximum number of requests allowed per a given time window for regular users, the time window in units of seconds, at least one dictionary to track request counts for regular users, a set of privileged user credentials, etc. Example pseudocode 300 also illustrates a function to process incoming requests, which includes determining if a user associated with a request is a privileged user. If the user (per the corresponding user credentials) is determined to be a privileged user, the user is granted the highest priority level. If the user (per the corresponding user credentials) is determined to be a regular user, the user’s request count within the given time window is checked. If the number of requests made by the user within the given time window is less than the maximum number of requests permitted, the request is transitioned to a request prioritization queue, the user’s count is incremented, and a given priority level (e.g., a lower priority level than is assigned to privileged users) is assigned to the user request. If the number of requests made by the user within the given time window exceeds the maximum number of requests permitted, then the request is rejected. With respect to the request prioritization queue, example pseudocode 300 illustrates steps including assigning priority levels to requests in the queue based at least in part on user type, and adding the requests (annotated with the assigned priority levels) to the queue.

It is to be appreciated that this particular example pseudocode shows just one example implementation of automated user-centric server management, and alternative implementations can be used in other embodiments.

FIG. 4 is a flow diagram of a process for automated user-centric server management in an illustrative embodiment. It is to be understood that this particular process is only an example, and additional or alternative processes can be carried out in other embodiments.

In this embodiment, the process includes steps 400 through 408. These steps are assumed to be performed by the automated server management system 105 utilizing elements 112, 114 and 116.

Step 400 includes obtaining multiple requests for access to one or more server-related resources in connection with at least one time period. In at least one embodiment, the at least one time period includes a time period corresponding to a level of server traffic exceeding a designated threshold.

Step 402 includes identifying at least a first portion of the multiple requests as corresponding to a first category of user type and at least a second portion of the multiple requests as corresponding to a second category of user type by processing user credentials associated with the multiple requests. In one or more embodiments, identifying at least a first portion of the multiple requests as corresponding to the first category of user type includes determining that the first portion of the multiple requests are associated with users having one or more designated server access privileges by comparing user credentials associated with the first portion of the multiple requests with a predefined set of user credentials attributed to users having the one or more designated server access privileges.

Step 404 includes automatically processing, during the at least one time period, the first portion of the multiple requests corresponding to the first category of user type. In at least one embodiment, automatically processing the first portion of the multiple requests corresponding to the first category of user type includes automatically granting access, to the first portion of the multiple requests as prioritized over the second portion of the multiple requests, to at least a portion of the one or more server-related resources.

Step 406 includes prioritizing, in at least one request queue data structure, the second portion of the multiple requests corresponding to the second category of user type based at least in part on one or more request volume parameters related to the at least one time period and at least a subset of the user credentials associated with the second portion of the multiple requests. In one or more embodiments, prioritizing the second portion of the multiple requests corresponding to the second category of user type includes determining a number of requests made, during the at least one time period, by each user associated with the second portion of the multiple requests. In such an embodiment, prioritizing the second portion of the multiple requests corresponding to the second category of user type can include comparing the number of requests made, during the at least one time period, by each user associated with the second portion of the multiple requests to a designated maximum request limit attributed to each of the users associated with the second portion of the multiple requests.

Such an embodiment can additionally include designating the maximum request limit attributed to each of the users associated with the second portion of the multiple requests based at least in part on server capacity in connection with the at least one time period. Also, in such an embodiment, prioritizing the second portion of the multiple requests corresponding to the second category of user type can include one of (i) delaying a given one of the second portion of the multiple requests upon a determination, based on the comparing, that the user associated with the given request has reached the designated maximum request limit attributed to the user, and (ii) rejecting the given request upon a determination, based on the comparing, that the user associated with the given request has reached the designated maximum request limit attributed to the user. Additionally or alternatively, prioritizing the second portion of the multiple requests corresponding to the second category of user type can include processing a given one of the second portion of the multiple requests upon a determination, based on the comparing, that the user associated with the given request has not reached the designated maximum request limit attributed to the user, and incrementing a request count attributed to the user associated with the given request.

Step 408 includes automatically processing, during the at least one time period, at least part of the second portion of the multiple requests corresponding to the second category of user type from the at least one request queue data structure in accordance with the prioritizing of the second portion of the multiple requests.

In one or more embodiments, the techniques depicted in FIG. 4 can also include configuring the at least one request queue data structure to temporarily store requests corresponding to the second category of user type and ordered based at least in part on priority levels assigned to the requests corresponding to the second category of user type. Further, such an embodiment can also include assigning the priority levels to the requests corresponding to the second category of user type based at least in part on the user credentials associated with the requests corresponding to the second category of user type.

Accordingly, the particular processing operations and other functionality described in conjunction with the flow diagram of FIG. 4 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to automatically prioritize and process server requests based at least in part on user credentials associated with the requests. These and other embodiments can effectively overcome problems associated with an inability to differentiate between regular users and privileged users, inducing usage latencies, and/or expanding server-related costs.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

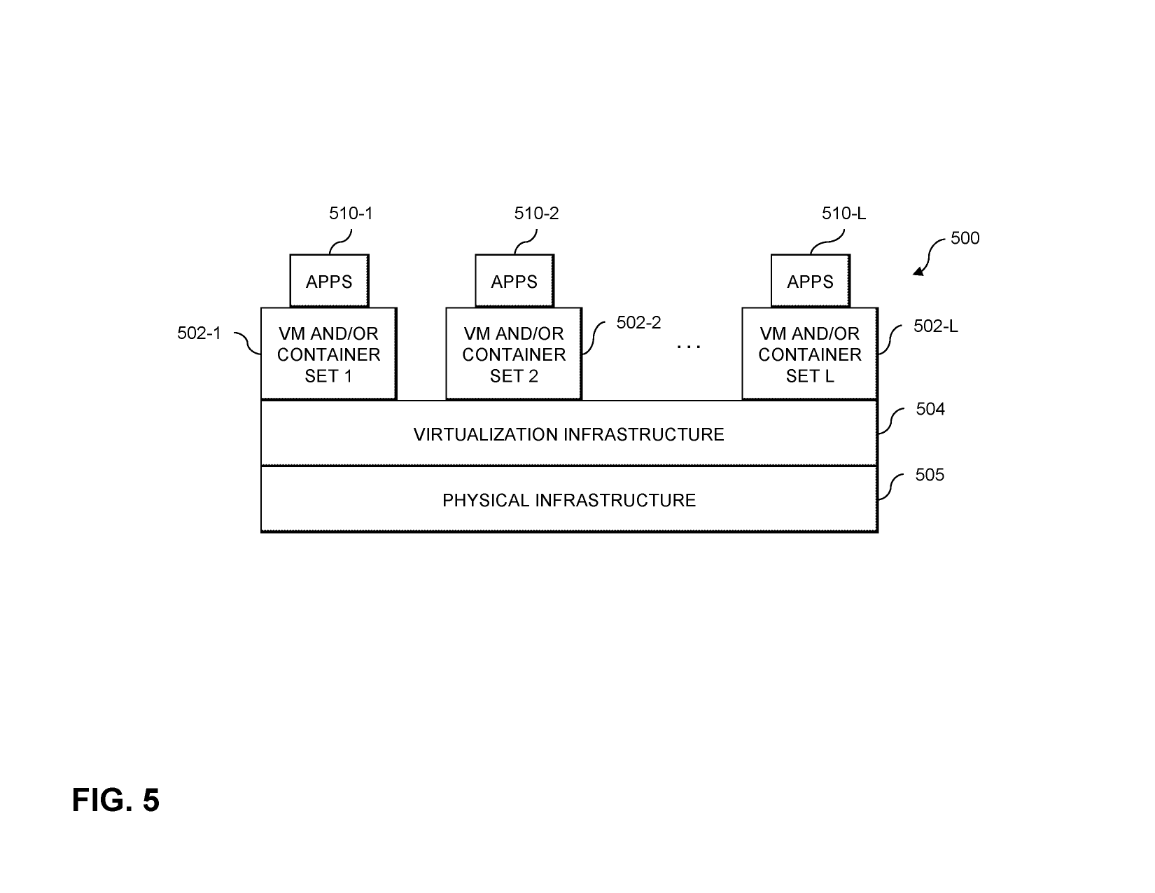

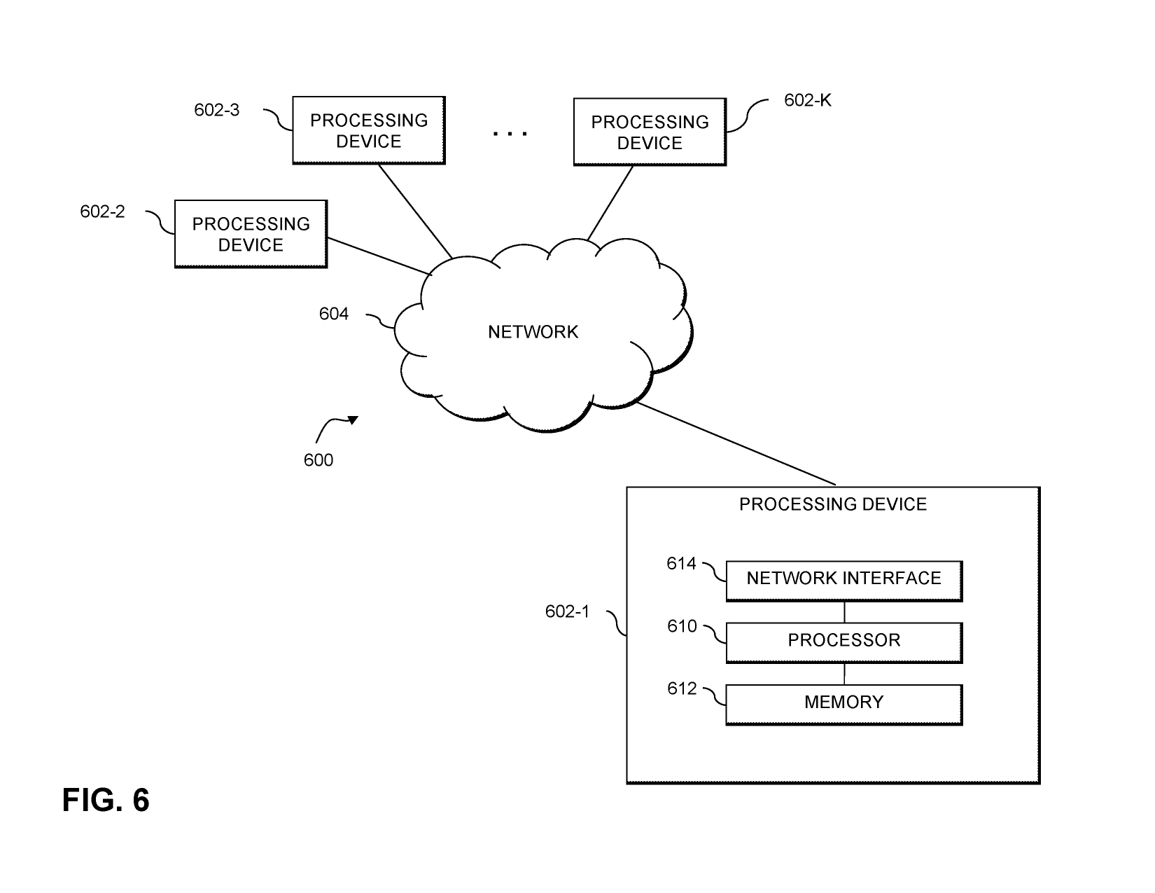

Illustrative embodiments of processing platforms will now be described in greater detail with reference to FIGS. 5 and 6. Although described in the context of system 100, these platforms may also be used to implement at least portions of other information processing systems in other embodiments.

FIG. 5 shows an example processing platform comprising cloud infrastructure 500. The cloud infrastructure 500 comprises a combination of physical and virtual processing resources that are utilized to implement at least a portion of the information processing system 100. The cloud infrastructure 500 comprises multiple virtual machines (VMs) and/or container sets 502-1, 502-2, . . . 502-L implemented using virtualization infrastructure 504. The virtualization infrastructure 504 runs on physical infrastructure 505, and illustratively comprises one or more hypervisors and/or operating system level virtualization infrastructure. The operating system level virtualization infrastructure illustratively comprises kernel control groups of a Linux operating system or other type of operating system.

The cloud infrastructure 500 further comprises sets of applications 510-1, 510-2, . . . 510-L running on respective ones of the VMs/container sets 502-1, 502-2, . . . 502-L under the control of the virtualization infrastructure 504. The VMs/container sets 502 comprise respective VMs, respective sets of one or more containers, or respective sets of one or more containers running in VMs. In some implementations of the FIG. 5 embodiment, the VMs/container sets 502 comprise respective VMs implemented using virtualization infrastructure 504 that comprises at least one hypervisor.

A hypervisor platform may be used to implement a hypervisor within the virtualization infrastructure 504, wherein the hypervisor platform has an associated virtual infrastructure management system. The underlying physical machines comprise one or more information processing platforms that include one or more storage systems.

In other implementations of the FIG. 5 embodiment, the VMs/container sets 502 comprise respective containers implemented using virtualization infrastructure 504 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 500 shown in FIG. 5 may represent at least a portion of one processing platform. Another example of such a processing platform is processing platform 600 shown in FIG. 6.

The processing platform 600 in this embodiment comprises a portion of system 100 and includes a plurality of processing devices, denoted 602-1, 602-2, 602-3, . . . 602-K, which communicate with one another over a network 604.

The network 604 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 602-1 in the processing platform 600 comprises a processor 610 coupled to a memory 612.

The processor 610 comprises a microprocessor, a CPU, a GPU, a TPU, a microcontroller, an ASIC, a FPGA or other type of processing circuitry, as well as portions or combinations of such circuitry elements.

The memory 612 comprises RAM, ROM or other types of memory, in any combination. The memory 612 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 602-1 is network interface circuitry 614, which is used to interface the processing device with the network 604 and other system components, and may comprise conventional transceivers.

The other processing devices 602 of the processing platform 600 are assumed to be configured in a manner similar to that shown for processing device 602-1 in the figure.

Again, the particular processing platform 600 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
obtaining multiple requests for access to one or more server-related resources in connection with at least one time period;
identifying at least a first portion of the multiple requests as corresponding to a first category of user type and at least a second portion of the multiple requests as corresponding to a second category of user type by processing user credentials associated with the multiple requests;
automatically processing, during the at least one time period, the first portion of the multiple requests corresponding to the first category of user type;
prioritizing, in at least one request queue data structure, the second portion of the multiple requests corresponding to the second category of user type based at least in part on one or more request volume parameters related to the at least one time period and at least a subset of the user credentials associated with the second portion of the multiple requests; and
automatically processing, during the at least one time period, at least part of the second portion of the multiple requests corresponding to the second category of user type from the at least one request queue data structure in accordance with the prioritizing of the second portion of the multiple requests;
wherein the method is performed by at least one processing device comprising a processor coupled to a memory.

2. The computer-implemented method of claim 1, wherein the at least one time period comprises a time period corresponding to a level of server traffic exceeding a designated threshold.

3. The computer-implemented method of claim 1, wherein identifying at least a first portion of the multiple requests as corresponding to the first category of user type comprises determining that the first portion of the multiple requests are associated with users having one or more designated server access privileges by comparing user credentials associated with the first portion of the multiple requests with a predefined set of user credentials attributed to users having the one or more designated server access privileges.

4. The computer-implemented method of claim 1, wherein prioritizing the second portion of the multiple requests corresponding to the second category of user type comprises determining a number of requests made, during the at least one time period, by each user associated with the second portion of the multiple requests.

5. The computer-implemented method of claim 4, wherein prioritizing the second portion of the multiple requests corresponding to the second category of user type comprises comparing the number of requests made, during the at least one time period, by each user associated with the second portion of the multiple requests to a designated maximum request limit attributed to each of the users associated with the second portion of the multiple requests.

6. The computer-implemented method of claim 5, further comprising:
designating the maximum request limit attributed to each of the users associated with the second portion of the multiple requests based at least in part on server capacity in connection with the at least one time period.

7. The computer-implemented method of claim 5, wherein prioritizing the second portion of the multiple requests corresponding to the second category of user type comprises one of (i) delaying a given one of the second portion of the multiple requests upon a determination, based on the comparing, that the user associated with the given request has reached the designated maximum request limit attributed to the user, and (ii) rejecting the given request upon a determination, based on the comparing, that the user associated with the given request has reached the designated maximum request limit attributed to the user.

8. The computer-implemented method of claim 5, wherein prioritizing the second portion of the multiple requests corresponding to the second category of user type comprises processing a given one of the second portion of the multiple requests upon a determination, based on the comparing, that the user associated with the given request has not reached the designated maximum request limit attributed to the user, and incrementing a request count attributed to the user associated with the given request.

9. The computer-implemented method of claim 1, further comprising:
configuring the at least one request queue data structure to temporarily store requests corresponding to the second category of user type and ordered based at least in part on priority levels assigned to the requests corresponding to the second category of user type.

10. The computer-implemented method of claim 9, further comprising:
assigning the priority levels to the requests corresponding to the second category of user type based at least in part on the user credentials associated with the requests corresponding to the second category of user type.

11. The computer-implemented method of claim 1, wherein automatically processing the first portion of the multiple requests corresponding to the first category of user type comprises automatically granting access, to the first portion of the multiple requests as prioritized over the second portion of the multiple requests, to at least a portion of the one or more server-related resources.

12. A non-transitory processor-readable storage medium having stored therein program code of one or more software programs, wherein the program code when executed by at least one processing device causes the at least one processing device:
to obtain multiple requests for access to one or more server-related resources in connection with at least one time period;
to identify at least a first portion of the multiple requests as corresponding to a first category of user type and at least a second portion of the multiple requests as corresponding to a second category of user type by processing user credentials associated with the multiple requests;
to automatically process, during the at least one time period, the first portion of the multiple requests corresponding to the first category of user type;
to prioritize, in at least one request queue data structure, the second portion of the multiple requests corresponding to the second category of user type based at least in part on one or more request volume parameters related to the at least one time period and at least a subset of the user credentials associated with the second portion of the multiple requests; and
to automatically process, during the at least one time period, at least part of the second portion of the multiple requests corresponding to the second category of user type from the at least one request queue data structure in accordance with the prioritizing of the second portion of the multiple requests.

13. The non-transitory processor-readable storage medium of claim 12, wherein the at least one time period comprises a time period corresponding to a level of server traffic exceeding a designated threshold.

14. The non-transitory processor-readable storage medium of claim 12, wherein identifying at least a first portion of the multiple requests as corresponding to the first category of user type comprises determining that the first portion of the multiple requests are associated with users having one or more designated server access privileges by comparing user credentials associated with the first portion of the multiple requests with a predefined set of user credentials attributed to users having the one or more designated server access privileges.

15. The non-transitory processor-readable storage medium of claim 12, wherein prioritizing the second portion of the multiple requests corresponding to the second category of user type comprises determining a number of requests made, during the at least one time period, by each user associated with the second portion of the multiple requests.

16. The non-transitory processor-readable storage medium of claim 15, wherein prioritizing the second portion of the multiple requests corresponding to the second category of user type comprises comparing the number of requests made, during the at least one time period, by each user associated with the second portion of the multiple requests to a designated maximum request limit attributed to each of the users associated with the second portion of the multiple requests.

17. An apparatus comprising:
at least one processing device comprising a processor coupled to a memory;
the at least one processing device being configured:
to obtain multiple requests for access to one or more server-related resources in connection with at least one time period;
to identify at least a first portion of the multiple requests as corresponding to a first category of user type and at least a second portion of the multiple requests as corresponding to a second category of user type by processing user credentials associated with the multiple requests;
to automatically process, during the at least one time period, the first portion of the multiple requests corresponding to the first category of user type;
to prioritize, in at least one request queue data structure, the second portion of the multiple requests corresponding to the second category of user type based at least in part on one or more request volume parameters related to the at least one time period and at least a subset of the user credentials associated with the second portion of the multiple requests; and
to automatically process, during the at least one time period, at least part of the second portion of the multiple requests corresponding to the second category of user type from the at least one request queue data structure in accordance with the prioritizing of the second portion of the multiple requests.

18. The apparatus of claim 17, wherein the at least one time period comprises a time period corresponding to a level of server traffic exceeding a designated threshold.

19. The apparatus of claim 17, wherein identifying at least a first portion of the multiple requests as corresponding to the first category of user type comprises determining that the first portion of the multiple requests are associated with users having one or more designated server access privileges by comparing user credentials associated with the first portion of the multiple requests with a predefined set of user credentials attributed to users having the one or more designated server access privileges.

20. The apparatus of claim 17, wherein prioritizing the second portion of the multiple requests corresponding to the second category of user type comprises determining a number of requests made, during the at least one time period, by each user associated with the second portion of the multiple requests.
